(19) United States
(12) Patent Application Publication
(10) Pub. No.: US 2010/0321289 A1
(43) Pub. Date: Dec. 23, 2010

(54) MOBILE DEVICE HAVING PROXIMITY SENSOR AND GESTURE BASED USER INTERFACE METHOD THEREOF

(75) Inventors: Eun Ji KIM, Suwon-si (KR); Tae Ho KANG, Seongnam-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/814,809

(22) Filed: Jun. 14, 2010

(30) Foreign Application Priority Data
Jun. 19, 2009 (KR) 10-2009-0054827

(51) Int. Cl. G06F 3/01

(52) U.S. Cl. 345/156

(57) ABSTRACT

A mobile device has a proximity sensor and a user interface based on a user's gesture detected using the proximity sensor. The gesture-based user interface method includes enabling proximity sensing through the proximity sensor, detecting a specific gesture through the proximity sensing, analyzing a pattern of the specific gesture, and executing a particular function assigned to the pattern.

### PRIORITY

This application claims the benefit under 35 U.S.C. §119(a) of a Korean patent application filed on Jun. 19, 2009 in the Korean Intellectual Property Office and assigned Serial No. 10-2009-0054827, the entire disclosure of which is hereby incorporated by reference.

### BACKGROUND OF THE INVENTION

1. Field of the Invention

The present invention relates to a mobile device. More particularly, the present invention relates to a mobile device having a proximity sensor and a method for realizing a user interface based on a user's gesture detected using the proximity sensor.

2. Description of the Related Art

With the dramatic advances in modern technology, a great variety of mobile devices have been ceaselessly developed and introduced. Moreover, rapid advances in mobile communication technologies are resulting in traditional mobile devices with many useful applications that meet customers' demands. For example, in addition to a call function, other useful functions and services, such as a camera function, a digital broadcasting service, a wireless internet service, a Short Message Service (SMS), a Multimedia Message Service (MMS), and the like have been provided to mobile devices. Such functions and services are now expanding into various, additional, personalized and specialized services.

Normally a user of such a mobile device should carry out an input action by pressing a selected key of a keypad or touching a selected point on a touch screen. However, this input scheme may often cause inconvenience to a user as the size of mobile devices are reduced. Accordingly, a more convenient user interface adapted to a size-limited mobile device is needed.

### SUMMARY OF THE INVENTION

An aspect of the present invention is to address at least the above-mentioned problems and/or disadvantages and to provide at least the advantages described below. Accordingly, an aspect of the present invention is to provide a mobile device and method allowing a user to conveniently input a gesture through a proximity sensor and also allowing the execution of a particular function depending on a pattern of a user's gesture.

Another aspect of the present invention is to provide a mobile device and method allowing the execution of different functions in response to the same user's gesture in consideration of a tilt variation of the mobile device.

In accordance with an aspect of the present invention, a gesture-based user interface method in a mobile device having a proximity sensor is provided. The method includes enabling a proximity sensing through the proximity sensor, detecting a specific gesture through the proximity sensing, analyzing a pattern of the specific gesture, and executing a particular function assigned to the pattern.

In accordance with another aspect of the present invention, a mobile device having a gesture-based user interface is provided. The mobile device includes a proximity sensor unit including an emitting part for emitting light when a switch is turned on through a control signal, and a plurality of receiving parts for detecting the light reflected from a specific gesture, and a control unit for detecting the specific gesture, for analyzing a pattern of the specific gesture, and for executing a particular function assigned to the pattern.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a block diagram illustrating the configuration of a mobile device according to an exemplary embodiment of the present invention;

FIG. 2 is a block diagram illustrating the configuration of a signal processing unit of a mobile device according to an exemplary embodiment of the present invention;

FIG. 3 is a flow diagram broadly illustrating a gesture-based user interface method of a mobile device according to an exemplary embodiment of the present invention;

FIGS. 4A to 4F are example views illustrating some ways of detecting a user's gesture in a mobile device having a proximity sensor according to an exemplary embodiment of the present invention;

FIG. 5 is a flow diagram illustrating a gesture-based user interface method depending on the proximity degree of a user's gesture according to an exemplary embodiment of the present invention;

FIG. 6 is a flow diagram illustrating a gesture-based user interface method depending on the direction of a user's gesture according to an exemplary embodiment of the present invention;

FIG. 7 is a flow diagram illustrating in detail a gesture-based user interface method of a mobile device according to an exemplary embodiment of the present invention;

FIGS. 8A to 8L are example views illustrating a gesture-based user interface method of a mobile device according to an exemplary embodiment of the present invention;

FIG. 9 is a flow diagram illustrating a process of setting up a gesture pattern to be used for a gesture-based user interface method of a mobile device according to an exemplary embodiment of the present invention;

FIGS. 10A to 10E are example views illustrating a process of setting up a gesture pattern for a gesture-based user interface according to an exemplary embodiment of the present invention; and

FIG. 11 is a flow diagram illustrating a gesture-based user interface method depending on a tilt variation of a mobile device according to an exemplary embodiment of the present invention.

Throughout the drawings, it should be noted that like reference numbers are used to depict the same or similar elements, features, and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments can be made without departing from the scope of the invention. In addition, descriptions of well-known functions and constructions are omitted for clarity and conciseness.

The terms and words used in the following description and claims are not limited to the bibliographical meanings, but are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Furthermore, well known or widely used techniques, elements, structures, and processes may not be described or illustrated in detail to avoid obscuring the essence of the present invention. Although the drawings represent exemplary embodiments of the invention, the drawings are not necessarily to scale and certain features may be exaggerated or omitted in order to better illustrate and explain the present invention.

Among terms set forth herein, a gesture refers to a motion of the limbs or body detected by a proximity sensor of a mobile device. The gesture may also be a motion of another object (other than the mobile phone). A gesture may be classified into a first gesture and a second gesture. The first gesture refers to a gesture having variations in the direction of a user's motion such as up, down, right and left directions with respect to a proximity sensor. The second gesture refers to a gesture having variations in the proximity degree of a user's motion, namely, variations in distance between a user's motion and a proximity sensor. The second gesture has variations in the strength of light reflected from a user's motion and received by a proximity sensor.

In accordance with exemplary embodiments of the present invention, a mobile device detects a user's gesture and then determines the direction and proximity degree of a detected gesture. Simultaneous use of two types of proximity sensing techniques may allow a more precise detection of a user gesture.

In accordance with an exemplary embodiment of the present invention, in order to detect a user's gesture in view of its proximity degree corresponding to the strength of light, the mobile device may receive a light signal reflected due to the user's gesture, remove a harmonic noise from a received signal using a Low Pass Filter (LPF), amplify a noise-removed signal using an amplifier, and compare the amplified signal with respective threshold values differently predefined in two comparators. Additionally, in order to detect a user's gesture in view of its proximity degree, a mobile device may convert an amplified signal into a digital signal using an Analog Digital Convertor (ADC), and compare the converted signal with a given reference value.

In accordance with another exemplary embodiment of the present invention, in order to detect a user's gesture in view of its direction, a mobile device may check a received time of an amplified signal delivered from each amplifier, perform a subtract operation for such times, and determine the order of light detection in receiving parts. For instance, when two receiving parts are located to the right and left sides or the upper and lower sides of an emitting part, a mobile device may determine the direction of a user's gesture in up and down directions or in right and left directions. When four receiving parts are respectively located to four sides of an emitting part, a mobile device may determine the direction of a user's gesture in four directions.

A mobile device having a proximity sensor according to exemplary embodiments of the present invention may include, but is not limited to, a great variety of devices, such as a mobile communication device, a Personal Digital Assistant (PDA), an International Mobile Telecommunication 2000 (IMT-2000) device, a smart phone, a Portable Multimedia Player (PMP), an MP3 player, a navigation device, a notebook, and any other equivalents.

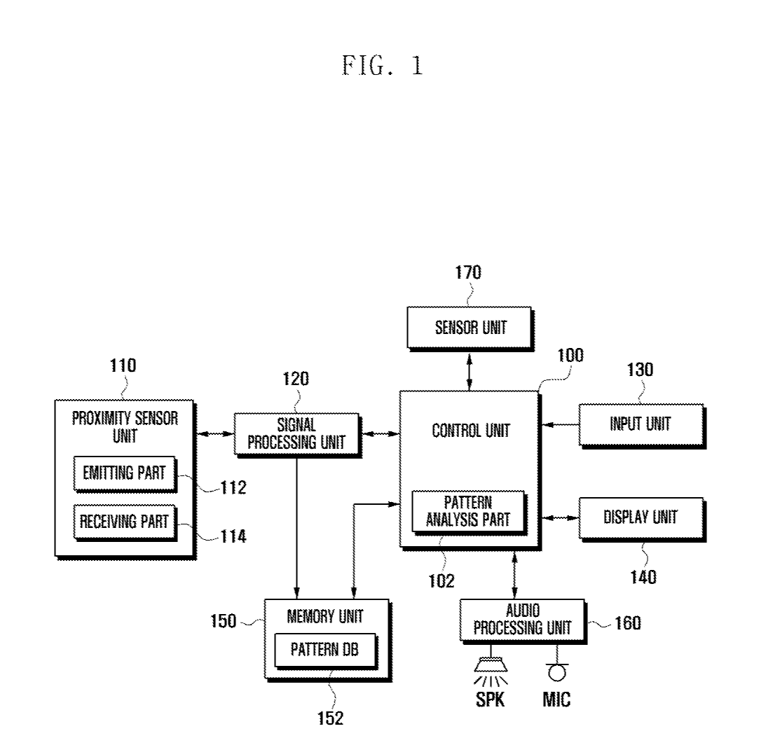

FIG. 1 is a block diagram illustrating the configuration of a mobile device according to an exemplary embodiment of the present invention.

Referring to FIG. 1, the mobile device includes a control unit 100, a proximity sensor unit 110, a signal processing unit 120, an input unit 130, a display unit 140, a memory unit 150, an audio processing unit 160, and a sensor unit 170. The proximity sensor unit 110 includes an emitting part 112 and a receiving part 114. The memory unit 150 also includes a pattern database 152, and the control unit 100 includes a pattern analysis part 102.

The proximity sensor unit 110 emits light, detects a physical signal (such as a user's gesture or the motion of an object inputted from the outside), and transmits the detected signal to the signal processing unit 120. The proximity sensor unit 110 may employ an infrared (IR) sensor, which utilizes infrared light to detect the approach of an external object into a detection area with a given range. In this case, the proximity sensor unit 110 may have the emitting part 112 formed of an infrared Light Emitting Diode (IR LED) which emits infrared light, and the receiving part 114 may be formed of a suitable detector, such as a diode or a transistor, which receives the reflected light.

The emitting part 112 emits light outwardly in order to measure an approaching distance of an external object under the control of the control unit 100. The receiving part 114 detects light reflected from an external object via a suitable detector. According to an exemplary embodiment of the present invention, the emitting part 112 emits a given amount of light depending on a signal amplified through the signal processing unit 120. The receiving part 114 sends a signal corresponding to light detected through the detector to the signal processing unit 120. In some exemplary embodiments, the proximity sensor unit 110 may include two receiving parts in order to detect a user's gesture in up and down directions or in right and left directions. Alternatively, the proximity sensor unit 110 may include four receiving parts for detection in four directions.

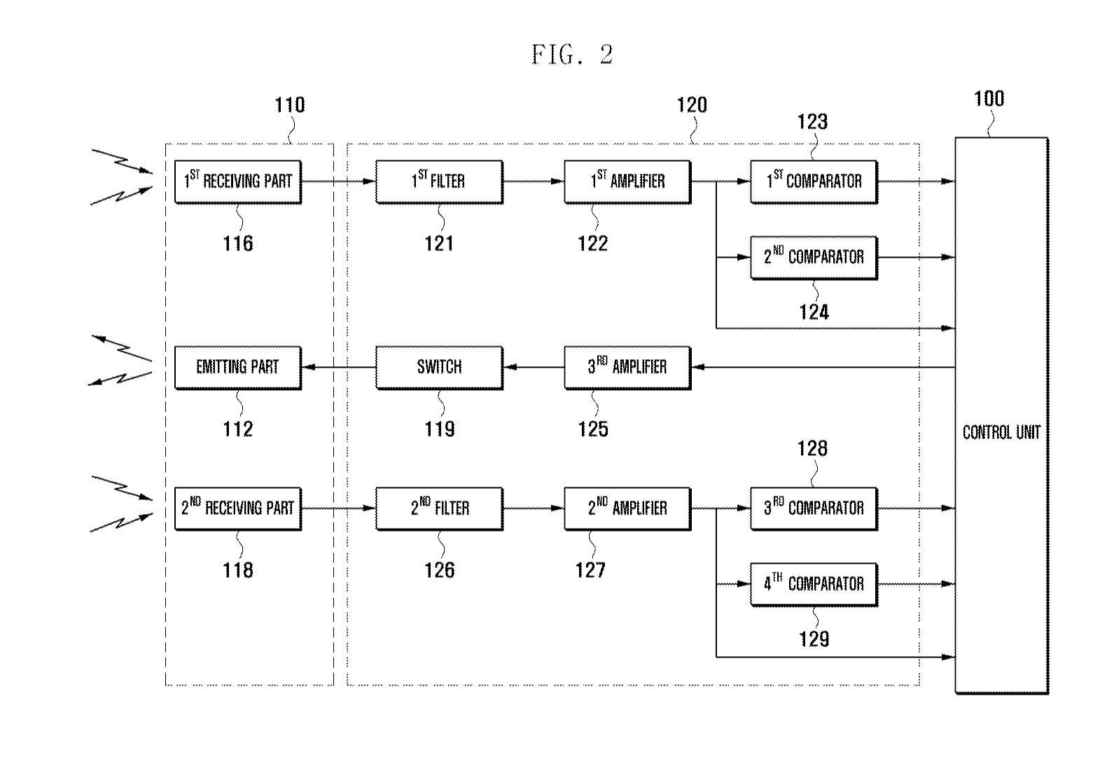

The signal processing unit 120 may amplify electric power according to a clock signal generated in the control unit 100. The signal processing unit 120 may include an amplifier for amplifying a light signal detected by the receiving part 114, and a comparator for comparing the amplified signal delivered from the amplifier with a threshold value previously set therein. The amplifier may include, but is not limited to, a transistor, an operational amplifier (OP AMP), and other devices capable of amplifying electric signals. The comparator outputs the result of the comparison between the amplified signal and a given threshold value. In addition, the signal processing unit 120 may have a switch to control light emitted from the emitting part 112. The signal processing unit 120 will be described in detail with reference to FIG. 2.

FIG. 2 is a block diagram illustrating the configuration of a signal processing unit of a mobile device according to an exemplary embodiment of the present invention.

Referring to FIG. 2, the signal processing unit 120 may include a first filter 121, a first amplifier 122, a first comparator 123, a second comparator 124, a switch 119, a third amplifier 125, a second filter 126, a second amplifier 127, a third comparator 128, and a fourth comparator 129. The switch 119 is controlled depending on a control signal of the control unit 100, and thereby light can be emitted through the emitting part 112. Namely, when a proximity sensing mode is enabled, the third amplifier 125 receives a control signal from the control unit 100 and hence amplifies electric power. Then the third amplifier 125 sends amplified electric power to the emitting part 112 by connecting the switch 119, and thereby the emitting part 112 emits light depending on amplified electric power.

If the proximity sensor unit 110 of the mobile device has two or more receiving parts 114, signals of light detected by the respective receiving parts may be sent to different amplifiers through different filters. When the receiving part 114 is composed of a first receiving part 116 and a second receiving part 118, the first receiving part 116 detects light reflected due to a user's gesture and sends a signal of the reflected light to the first filter 121 to remove a harmonic noise. The first amplifier 122 amplifies a noise-removed signal and sends a first amplified signal to the first and second comparators 123 and 124 and the control unit 100. The first and second comparators 123 and 124 each performs a comparison between a given threshold value and the first amplified signal and thereby creates comparison data. The control unit 100 performs a comparison between a given reference value and the first amplified signal and thereby creates comparison data.

The second receiving part 118 detects light reflected from a user's gesture and sends a reflected light signal to the second filter 126 to remove harmonic noise. The second amplifier 127 amplifies the noise-removed signal and sends a second amplified signal to the third and fourth comparators 128 and 129 and the control unit 100. The third and fourth comparators 128 and 129 each performs a comparison between a given threshold value and the second amplified signal and thereby creates comparison data. The control unit 100 performs a comparison between a given reference value and the second amplified signal and thereby creates comparison data. The comparison data may be used to determine the proximity degree of a user's gesture, which corresponds to the strength of received light. The threshold value in each comparator and the reference value in the control unit are particular values to be used for a comparison with an amplified signal. Such values may be set in advance during the manufacture of a mobile device. Additionally, the values may be adjusted by the user.

The control unit 100 compares the received time of signals received from the first and second amplifiers 122 and 127 and thereby determines the direction of a user's gesture.

The input unit 130 includes a plurality of normal input keys configured to receive inputs of letters and numbers and special function keys configured to receive given particular instructions. The input unit 130 creates various input signals in association with user's instructions and delivers them to the control unit 100. The input unit 130 may have at least one of a keypad and a touchpad. The input unit 130, together with the display unit 140, may be formed of a touch screen which performs a dual role of input and display.

The display unit 140 displays a variety of information on a screen in association with the operation of the mobile device. The display unit 140 displays on a screen suitable menu items, user's input data, and any other graphical elements. The display unit 140 may be formed of a Liquid Crystal Display (LCD), an Organic Light Emitting Device (OLED), or equivalents. Where a touch screen is used, the display unit 140 may correspond to a display part of the touch screen.

The memory unit 150 stores a variety of applications and data required for the operation of the mobile device. The memory unit 150 has a program region and a data region. The program region may store an Operating System (OS) for booting the mobile device, a program for recognizing the strength of light and thereby determining the proximity degree of a user's gesture, a program for determining the direction of a user's gesture, a program for determining a gesture pattern based on the proximity degree of a user's gesture, a program for determining a gesture pattern based on the direction of a user's gesture, a program for setting up gesture patterns, and a program for analyzing a gesture pattern based on a tilt variation of a mobile device. The data region may store data created while the mobile device is used. The data region may store gesture patterns analyzed depending on a user's gesture and also gesture patterns predefined by a user. Such patterns may be used to establish the pattern database 152.

The audio processing unit 160 receives audio signals from the control unit 100 and then outputs audible sounds through the speaker (SPK), or receives audio signals from the microphone (MIC) and outputs audio data to the control unit 100. The audio processing unit 160 converts digital audio signals inputted from the control unit 100 into analog audio signals to be outputted through the speaker (SPK), and also converts analog audio signals inputted from the microphone (MIC) into digital audio signals.

The sensor unit 170 is configured to recognize a tilt variation of a mobile device. The sensor unit 170 may include at least one of an acceleration sensor and a geomagnetic sensor. The acceleration sensor detects the motion of the mobile device and offers detection data to the control unit 100. In case of a multi-axis model, the acceleration sensor can detect the magnitude and direction of the motion in the three dimensional space. The geomagnetic sensor detects the direction of the mobile device and offers detection data to the control unit 100. The geomagnetic sensor can detect the direction of the mobile device based on absolute orientation.

The control unit 100 controls the whole operations of the mobile device and the flow of signals between internal blocks in the mobile device. According to an exemplary embodiment of the present invention, the control unit 100 may convert analog signals into digital signals. The control unit 100 may enable a proximity sensing mode by controlling the proximity sensor unit 110 at a user's request. One proximity sensing mode recognizes the proximity degree of a user's gesture using the strength of light, and the other recognizes the direction of a user's gesture using a difference in detection time of light at the receiving parts. When such a proximity sensing mode is enabled, the control unit 100 controls the emitting part 112 to emit light by supplying electric power to the emitting part 112.

The control unit 100 may compare a signal amplified in the signal processing unit 120 with a given threshold value in a specific comparator and thereby determine the strength of light. The control unit 100 may determine the strength of light which corresponds to a distance between the proximity sensor unit 110 and a user's gesture. The control unit 100 may detect a greater amount of light when a user's gesture occurs at a shorter distance from the proximity sensor unit 110. Normally the emitting part 112 emits a uniform quantity of light. Accordingly, as an object reflecting light becomes more distant from the proximity sensor unit 110, the quantity of light received in the receiving part 114 decreases for several reasons, such as scattering of light.

If the proximity sensor unit 110 has a plurality of receiving parts 114, the control unit 100 may determine the direction of a user's gesture by calculating a difference in time when each receiving part 114 detects light. The control unit 100 may determine that a user's gesture is made from one receiving part firstly detecting light to other receiving part lastly detecting light.

In a gesture pattern recognition mode, the control unit 100 may detect a user's gesture inputted through the proximity sensor unit 110. The proximity sensor unit 110 may emit light through the emitting part 112 depending on the switch 119 of the signal processing unit 120. In order to prevent the malfunction of the proximity sensor unit 110, the signal processing unit 120 may enable the switch 119 according to a control signal of the control unit 100. When a user's gesture is detected, the control unit 100 may analyze a pattern of a detected gesture. A gesture pattern may be upward, downward, rightward, and leftward patterns, or any other patterns. The control unit 100 may execute a particular function assigned to such a gesture pattern. In a gesture pattern setting mode, the control unit 100 may set up a variety of user-defined gesture patterns to execute particular functions, such as selection, cancel, execution, hot key, speed dial, and the like. Such user-defined gesture patterns may be preferably formed of combination of two or more patterns.

The control unit 100 may interpret the same gesture as different patterns, depending on a tilt variation at the sensor unit 170. The control unit 100 may recognize a gesture pattern based on the posture of the mobile device by enabling a three-axis geomagnetic sensor or a six-axis combined sensor (i.e., a three-axis geomagnetic sensor and a three-axis acceleration sensor). In order to effectively perform the above operation, the control unit 100 includes the pattern analysis part 102 which analyzes a gesture pattern based on a posture of the mobile device (i.e., tilted or non-tilted).

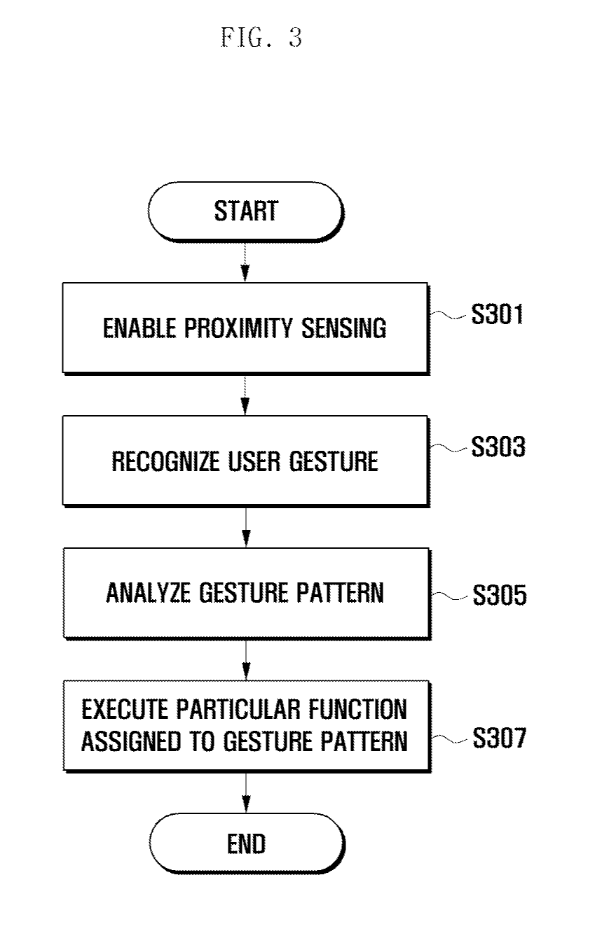

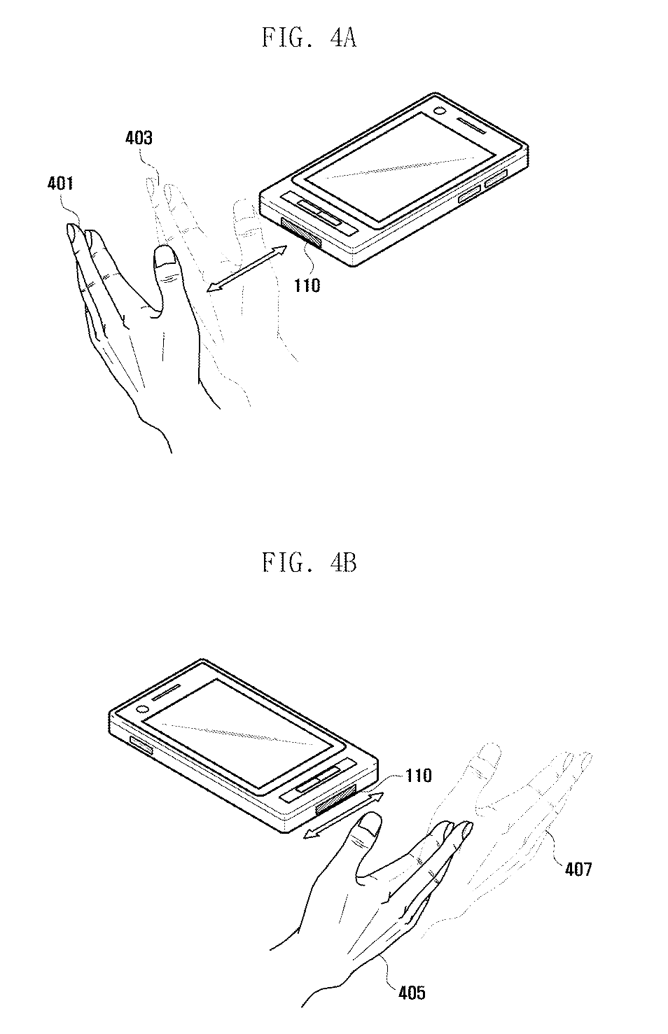

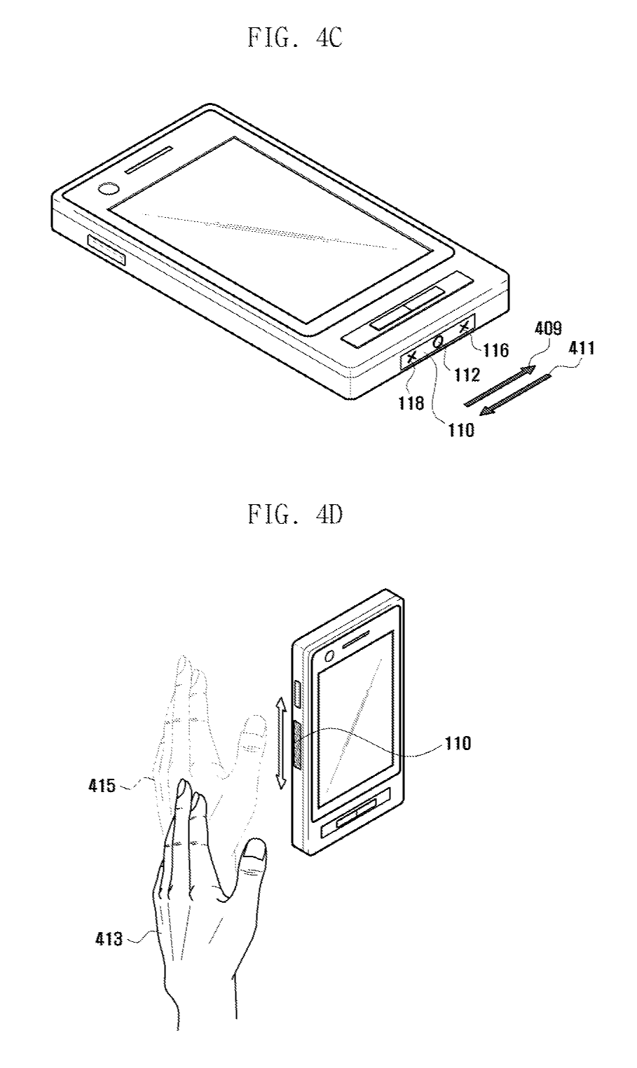

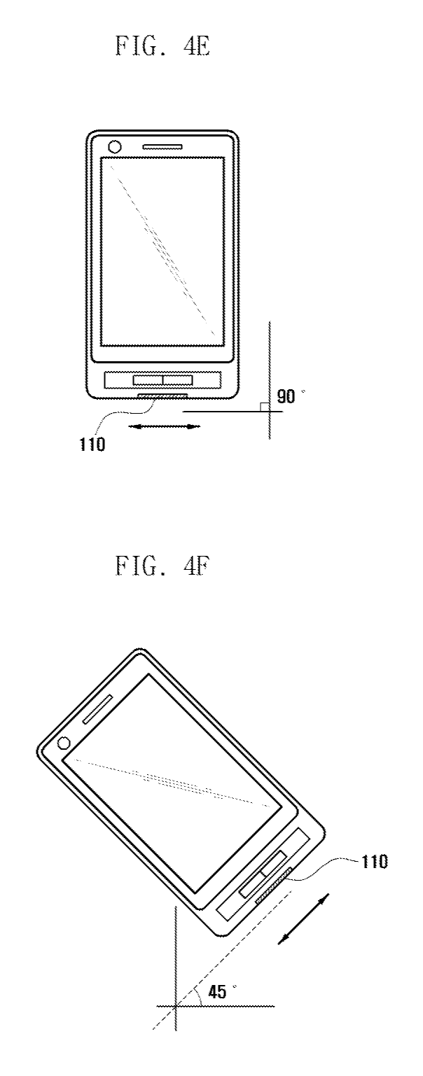

FIG. 3 is a flow diagram broadly illustrating a gesture-based user interface method of a mobile device according to an exemplary embodiment of the present invention. In addition, FIGS. 4A to 4F are example views illustrating some ways of detecting a user's gesture in a mobile device having a proximity sensor according to an exemplary embodiment of the present invention.

Referring to FIGS. 3 to 4F, the mobile device according to an exemplary embodiment of the present invention enables a proximity sensing mode at a user's request in step S301. The proximity sensing mode allows the mobile device to recognize a gesture pattern by depending on the strength of light and the direction of a user's gesture and to execute a particular function assigned to a recognized gesture pattern. The mobile device may control the signal processing unit 120 such that the proximity sensor unit 110 can be supplied with electric power through the switch 119. The emitting part 112 continues to emit light until the switch is turned off via a signal of the control unit 100.

When the proximity sensing mode is enabled, the mobile device recognizes a user's gesture in step S303. As discussed above, a user's gesture may have variations in its proximity degree or in its direction.

The mobile device detects light reflected from a user's gesture and performs a signal processing for a signal of detected light. The signal processing unit 120 may amplify a signal delivered from the receiving part 114 and then an amplified signal to the comparators therein and the control unit 100. The signal processing unit 120 may deliver data, created by a comparison between an amplified signal and a given threshold value, to the control unit 100. The control unit 100 may convert a received signal into a digital signal and create data by a comparison between a received signal and a given reference value. The control unit 100 may analyze such data, determine the proximity degree of a user's gesture using the strength of light, and thereby recognize a user's gesture.

Additionally, the control unit 100 may determine a difference in time when each receiving part 114 detects light reflected from a user's gesture. The control unit 100 may check the received time of an amplified signal, determine the direction of a user's gesture using the location of the receiving part detecting light, and thereby recognize a user's gesture.

For example, as shown in FIG. 4A, the mobile device detects a greater amount of light when a user's gesture occurs at a point 403 closer to the proximity sensor unit 110 than at a more distant point 401.

As shown in FIG. 4B, the mobile device determines the direction of a user's gesture by performing a subtract operation for detection time of signals of light inputted into the receiving parts. The control unit 100 may recognize that a user's gesture has the direction from a left place 405 to a right place 407 or the opposite direction.

Specifically, as shown in FIG. 4C, the proximity sensor unit 110 may be composed of the emitting part 112, the first receiving part 116 and the second receiving part 118. While the emitting part 112 emits light, the first and second receiving parts 116 and 118 receive light respectively. The control unit 100 calculates a difference in time when each receiving part detects a peak signal of received light. If the second receiving part 118 detects light earlier than the first receiving part 116, the control unit 100 determines that a user's gesture has a rightward direction 409. Similarly, if the first receiving part 116 detects light earlier than the second receiving part 118, the control unit 100 determines that a user's gesture has a leftward direction 411.

As shown in FIG. 4D, the mobile device determines the direction of a user's gesture by performing subtract operation for detection time of signals of light inputted into the receiving parts. The control unit 100 may recognize that a user's gesture has the direction from a lower place 413 to an upper place 415 or the opposite direction.

Returning to FIG. 3, when a user's gesture is detected, the mobile device analyzes a pattern of a detected gesture in step S305. A gesture pattern may be a single pattern with an upward, downward, rightward, or leftward direction, or one of any other user-defined patterns. A single pattern corresponds to a simple gesture with a single direction. A user-defined pattern is established in a gesture pattern setting mode as a complex pattern assigned to a user-selected particular function. Also, a single pattern may correspond to a gesture depending on the strength of light.

The control unit 100 may analyze a gesture pattern by detecting a tilt variation at the sensor unit 170. The sensor unit 170 may have a three-axis acceleration sensor which detects the magnitude and direction of the motion of the mobile device in the three dimensional space and offers detection data to the control unit 100. Alternatively or additionally, the sensor unit 170 may have a geomagnetic sensor which detects the direction of the mobile device based on absolute orientation and offers detection data to the control unit 100. For example, as shown in FIG. 4E, if a tilt recognized by the sensor unit 170 is at a right angle with the ground, the control unit 100 may interpret a gesture pattern as a default meaning. On the other hand, as shown in FIG. 4F, if a tilt recognized by the sensor unit 170 is at an angle of 45 degrees with the ground, the control unit 100 may interpret a gesture pattern as a different meaning.

After a gesture pattern is analyzed, the mobile device executes a particular function assigned to a gesture pattern in step S307. If a gesture input is a single pattern, a particular function assigned to a gesture pattern may be a move in a selected direction, a regulation of sound volume, an entrance into lower-level menu, a slide manipulation, a scroll manipulation, a zooming in/out, and the like. If a gesture input is a user-defined pattern, a particular function assigned to a gesture pattern may be an activation of a user-selected menu or icon, a move to a higher-level menu, a halt of a running application, an execution of a hot key, an input of a password, a setting of speed dialing, and the like.

If a gesture input is a distance-dependent pattern based on the strength of light, a particular function assigned to a gesture pattern may be a selection or activation of a specific menu when the strength of light is increased, or a cancel of a selected menu or a return to a previous step when the strength of light is decreased. In addition, different functions may be assigned to the same gesture pattern according to a tilt variation of the mobile device. The commands described above are merely examples of commands that can be associated with gestures; other commands may also be associated with various gestures.

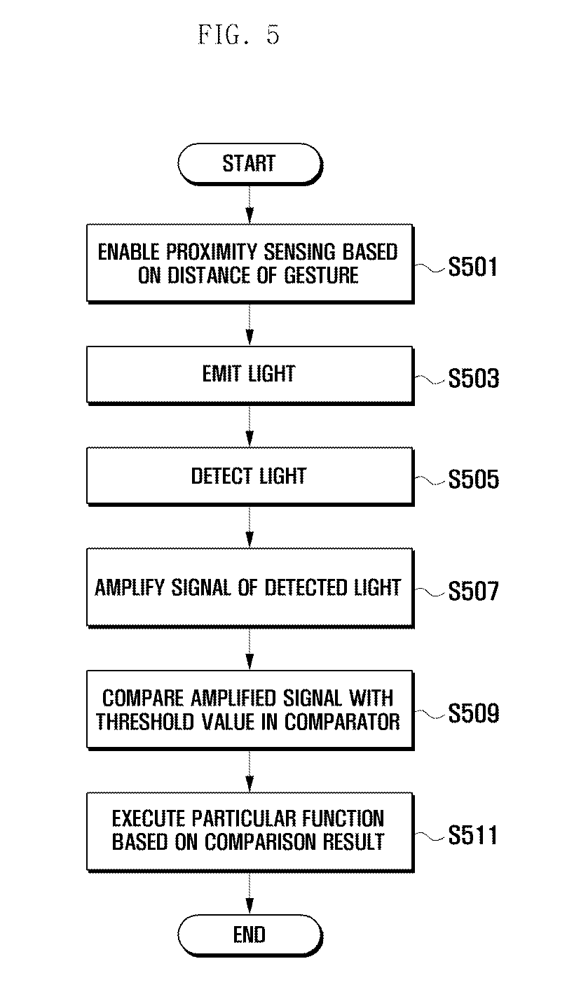

FIG. 5 is a flow diagram illustrating a gesture-based user interface method depending on the proximity degree of a user's gesture according to an exemplary embodiment of the present invention.

Referring to FIG. 5, in order to determine the strength of light, the control unit 100 enables a proximity sensing mode depending on a distance of a user's gesture to be inputted in step S501. When the proximity sensing mode is enabled, the control unit 100 transmits a control signal for turning on the switch 119 to the signal processing unit 120 so that the emitting part 112 may emit light. The signal processing unit 120 receives and amplifies electric power and supplies the power to the emitting part 112.

The emitting part 112 supplied with electric power emits light in step S503. The emitting part 112 continues to emit light until the control unit 100 sends a control signal for turning off the switch 119 to the signal processing unit 120. The emitting part 112 emits light regardless of whether the receiving part 114 detects light.

While light is emitted, the receiving part 114 detects reflected light in step S505. The receiving part 114 may convert detected light into an electric signal and transmits the signal to the signal processing unit 120.

The signal processing unit 120 amplifies a received signal through the amplifier equipped therein in step S507. The signal processing unit 120 sends an amplified signal to the comparators equipped therein. An amplified signal may also be sent to the control unit 100.

Using the comparators, the signal processing unit 120 compares an amplified signal with a given threshold value in each comparator in step S509. The mobile device may use two or more comparators with different threshold values. The signal processing unit 120 creates data of a comparison result and delivers the data to the control unit 100.

When receiving data of a comparison result, the control unit 100 analyzes received data and executes a predefined particular function according to an analysis result in step S511.

If the control unit 100 receives an amplified signal from the amplifier, the control unit 100 converts an amplified signal into a digital signal. The control unit 100 compares a converted signal with a given reference value and creates data of a comparison result. After creating comparison data, the control unit 100 analyzes the comparison data and then executes a particular function according to an analysis result.

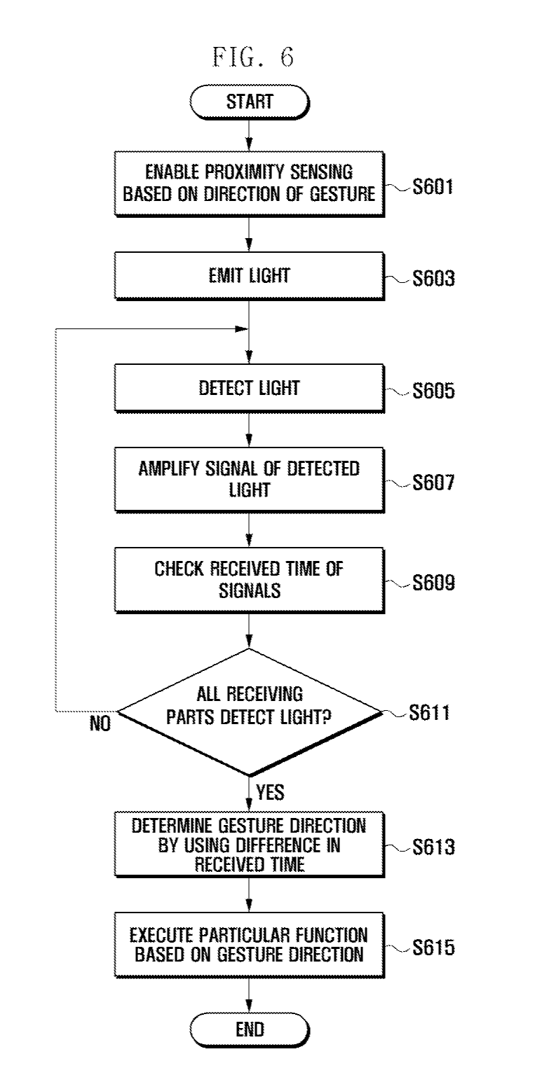

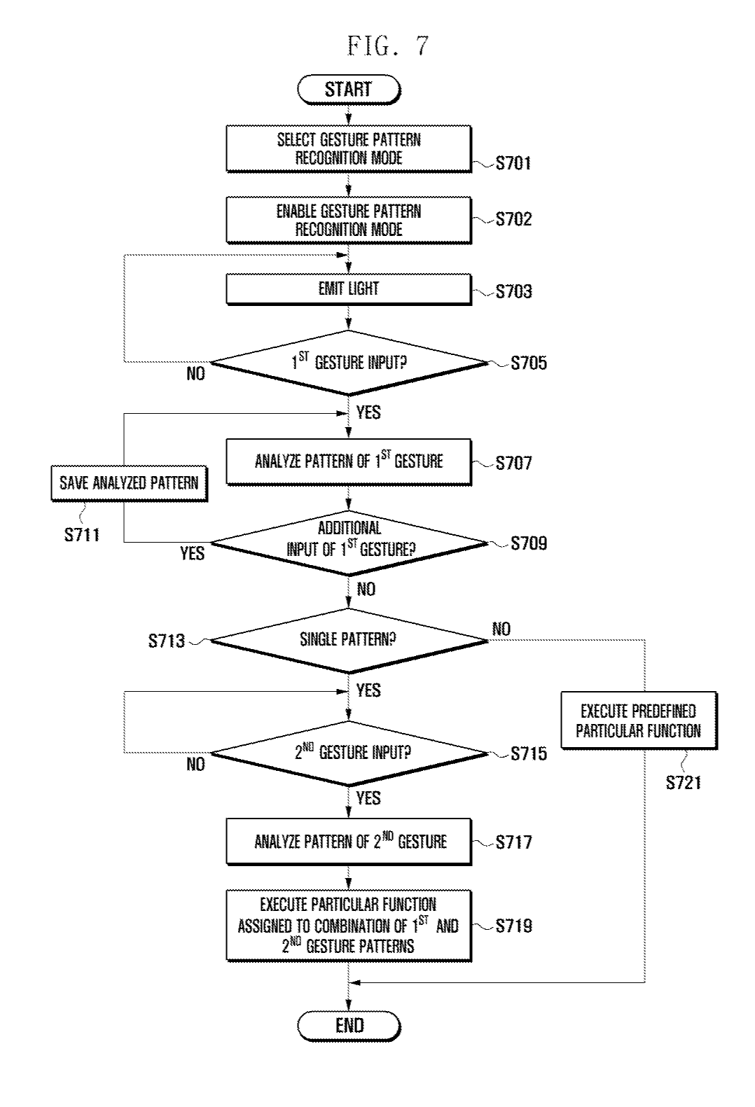

FIG. 6 is a flow diagram illustrating a gesture-based user interface method depending on the direction of a user's gesture according to an exemplary embodiment of the present invention.

Referring to FIG. 6, the control unit 100 enables a proximity sensing mode depending on the direction of a user's gesture in step S601. When this proximity sensing mode is enabled, the control unit 100 transmits a control signal for turning on the switch 119 to the signal processing unit 120 so that the emitting part 112 may emit light. The signal processing unit 120 receives and amplifies electric power and supplies it to the emitting part 112.

The emitting part 112 supplied with electric power emits light in step S603. While light is emitted, the receiving part 114 detects reflected light in step S605. The receiving part 114 may be composed of the first receiving part 116 and the second receiving part 118. The receiving part 114 may convert detected light into an electric signal and transmits the signal to the signal processing unit 120.

In step S607, the signal processing unit 120 amplifies the received signal through the amplifier equipped therein. An amplified signal may be sent to the control unit 100 or to the comparators for a comparison with given threshold values. The signal processing unit 120 may perform such a process for each of the first and second receiving parts 116 and 118. The control unit 100 may receive amplified signals from the first and third amplifiers 122 and 127.

The control unit 100 receiving amplified signals checks a time when such signals are received in step S609. In step S611, the control unit 100 determines whether all of the receiving parts detect light. If all receiving parts detect light, the control unit 100 can recognize the direction of a user's gesture by calculating a difference in time when amplified signals are delivered in step S613. For example, if the received time of a signal amplified in the first amplifier 122 is faster than that of a signal amplified in the second amplifier 127, the control unit 100 determines that the first receiving part 116 detects light earlier than the second receiving part 118. If data is received, the control unit 100 may check the received time of data and perform a subtract operation for the received time. The control unit 100 may determine the direction of a user's gesture depending on the result of subtract operation. If the receiving parts do not detect light in step S611, the control unit 100 continues to perform the previous steps from step S605.

When the direction of a user's gesture is recognized, the control unit 100 executes a particular function assigned to a gesture pattern corresponding to the direction in step S615. If the control unit 100 receives an amplified signal from the amplifier, each comparator compares an amplified signal with a given threshold value defined therein and sends data of a comparison result to the control unit 100.

FIG. 7 is a flow diagram fully illustrating a gesture-based user interface method of a mobile device according to an exemplary embodiment of the present invention.

Referring to FIG. 7, the control unit 100 receives a signal that selects a gesture pattern recognition mode in step S701. A gesture pattern recognition mode refers to a mode in which a pattern of a user's gesture detected by the proximity sensor is analyzed and hence a corresponding function is executed. The user's gesture may be a distance-dependent gesture or a direction-dependent gesture.

When receiving a signal for selecting a gesture pattern recognition mode, the control unit 100 enables a gesture pattern recognition mode in step S702. The control unit 100 may send a control signal for turning on the switch 119 to the signal processing unit 120 so that the emitting part 112 may emit light. The signal processing unit 120 receives and amplifies electric power and supplies the electric power to the emitting part 112.

After a gesture pattern recognition mode is enabled, the emitting part 112 supplied with electric power emits light in step S703. While light is emitted, the control unit 100 detects the first gesture input in step S705. The first gesture input may be a direction-dependent gesture, namely, having up and down directions or right and left directions.

If the first gesture is inputted, the control unit 100 analyzes a pattern of the first gesture in step S707. Otherwise, the operation returns to step 703. The control unit 100 may perform a pattern analysis using the direction of the first gesture inputted through the proximity sensor unit 110. For more effective analysis, the control unit 100 may use the pattern analysis part 102 specially offered therein.

After the pattern analysis, the control unit 100 determines whether there is an additional input for the first gesture in step S709. If any additional input is detected in connection with the first gesture, the control unit 100 saves an analyzed pattern in step S711 and performs a pattern analysis again for an additional input of the first gesture in the aforesaid step S707. If there is no additional input for the first gesture, the control unit 100 further determines whether an analyzed pattern is a single pattern in step S713.

In the case of a single pattern, the control unit 100 determines whether the second gesture input is detected through the proximity sensor unit 110 in step S715. The second gesture input may be a distance-dependent gesture based on the strength of light. When the second gesture with increasing strength of light is inputted, the control unit 100 may select or activate a specific menu. When the second gesture with decreasing strength of light is inputted, the control unit 100 may cancel a selected menu or return to a previous step. The control unit 100 may also execute a zooming function depending on the second gesture.

If the second gesture is inputted, the control unit 100 analyzes a pattern of the second gesture in step S717. The control unit 100 may perform a pattern analysis using the strength of light depending on the second gesture inputted through the proximity sensor unit 110. For more effective analysis, the control unit 100 may use the pattern analysis part 102 specially offered therein.

After the pattern analysis, the control unit 100 executes a particular function assigned to a combination of the first and second gesture patterns in step S719. For example, in this step, the control unit 100 may execute one of the following functions: a move in a selected direction, a regulation of sound volume, an entrance into a lower-level menu, a slide manipulation, and/or a scroll manipulation, a zooming in/out.

If it is determined in step S713 that an analyzed pattern is not a single pattern, the control unit 100 executes a particular function in step S721. For example, the control unit 100 may execute one of the following functions: an activation of a user-selected menu or icon, a move to a higher-level menu, a halt of a running application, an execution of a hot key, an input of a password, and a setting of speed dialing. In this case, the analyzed pattern may be a user-defined pattern.

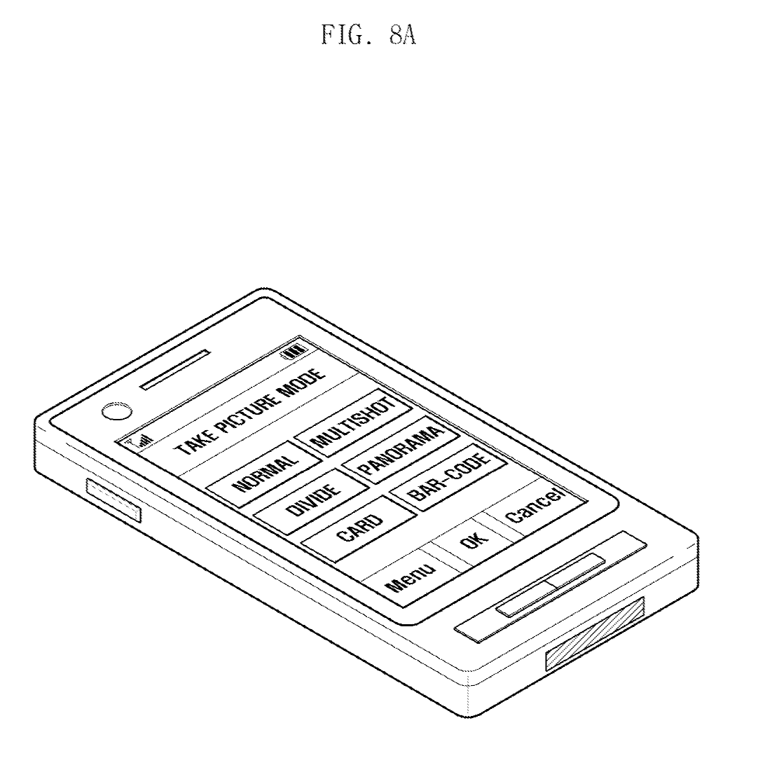

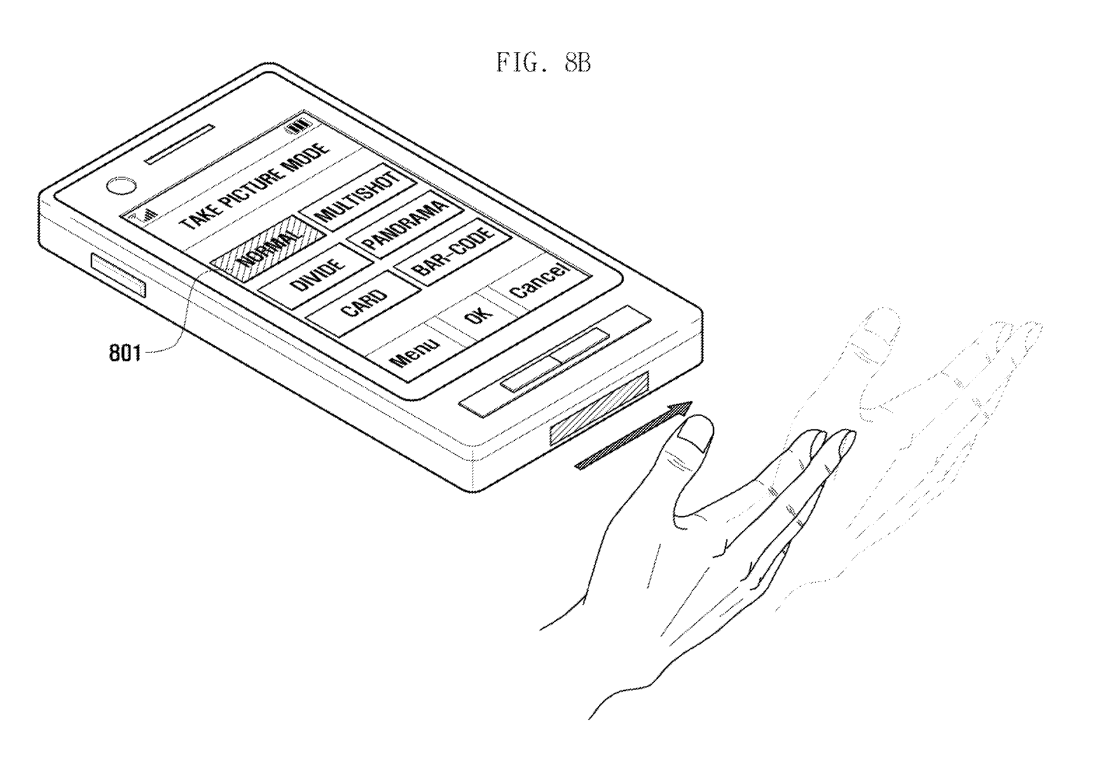

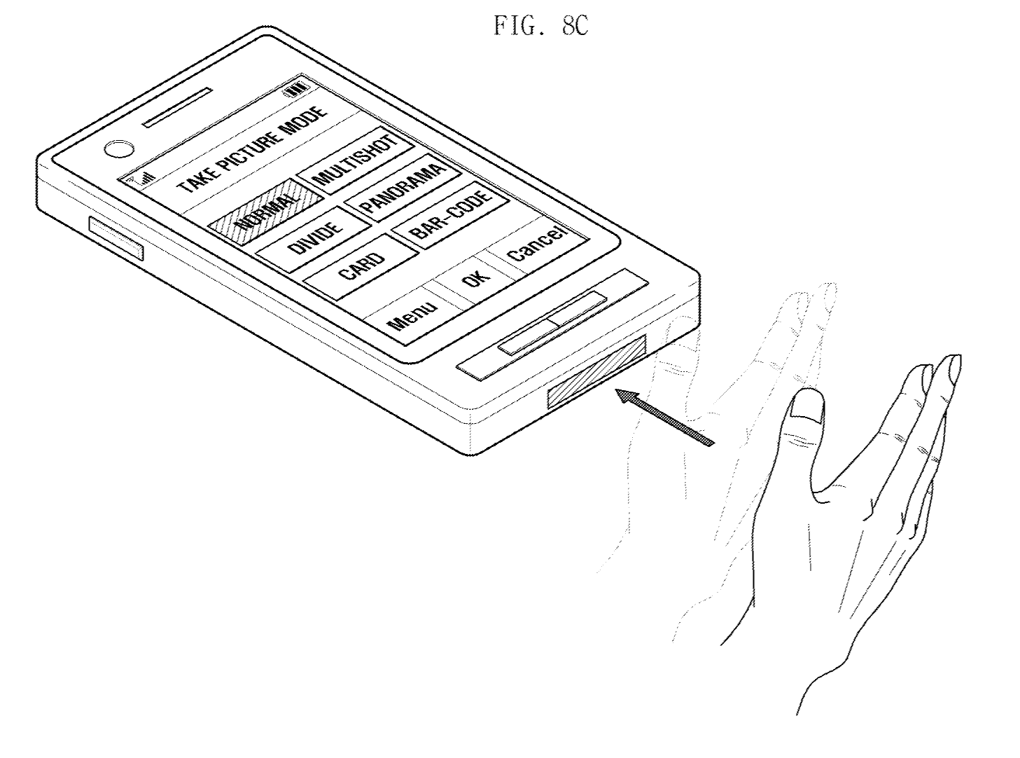

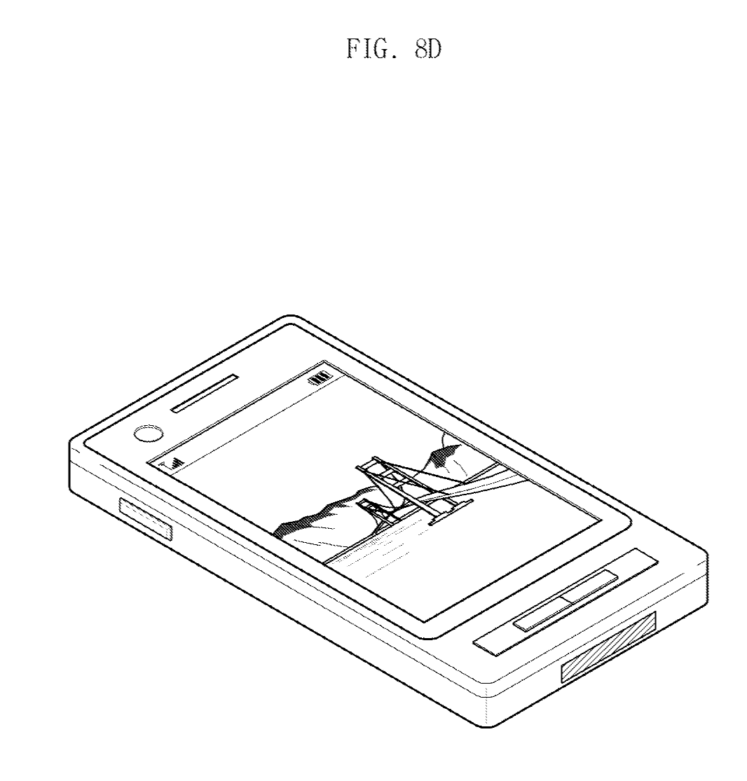

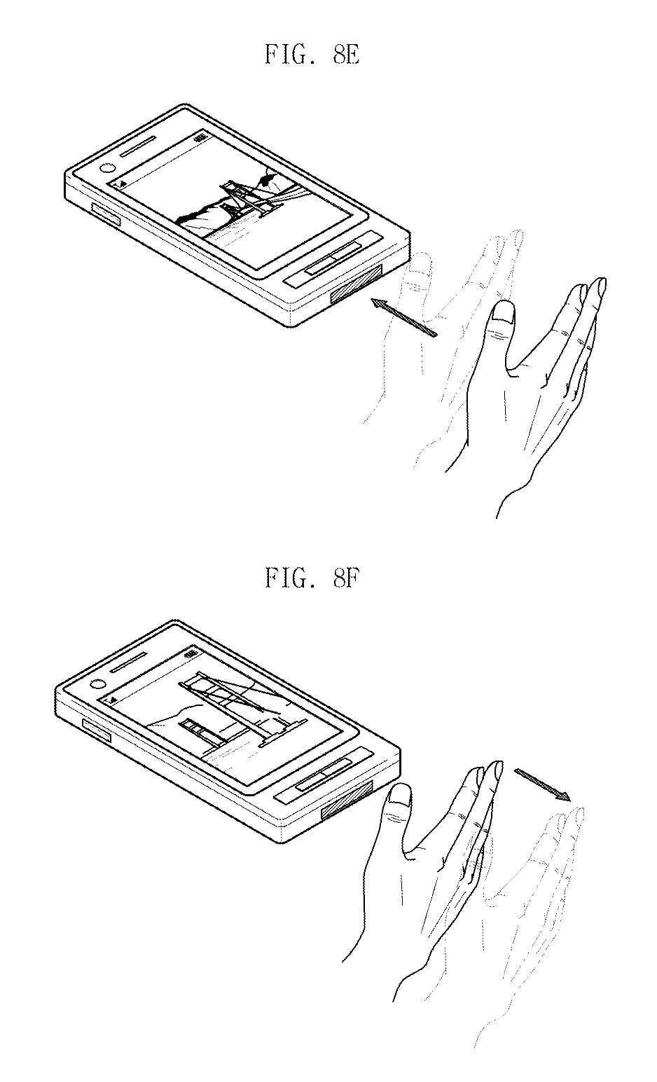

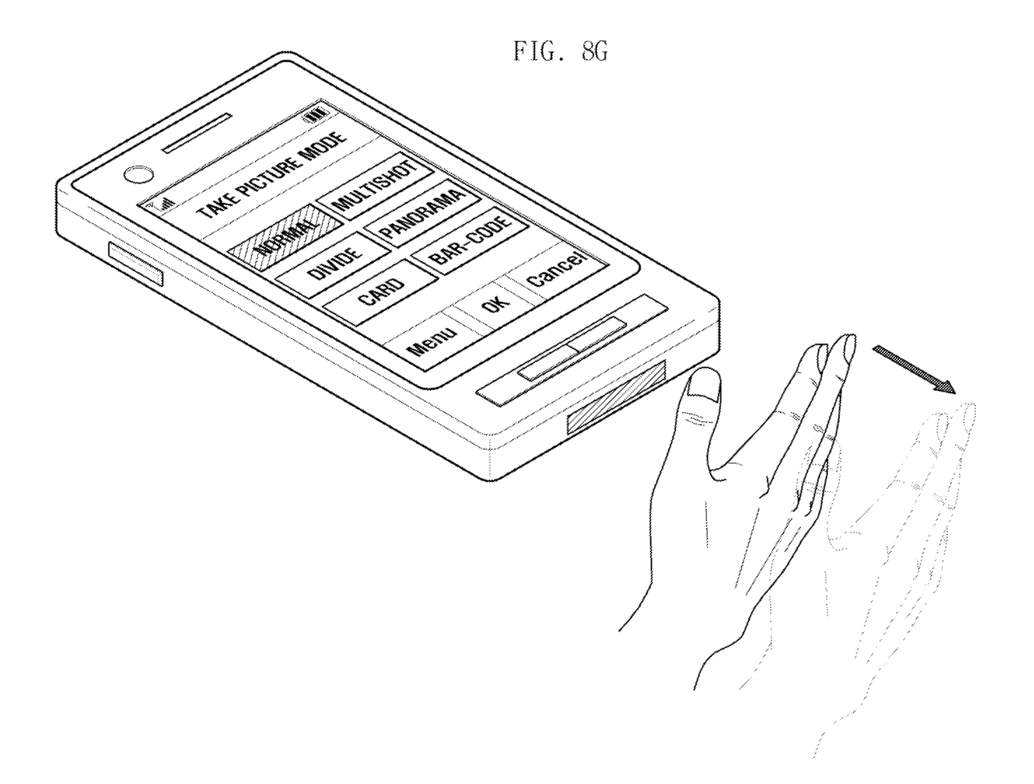

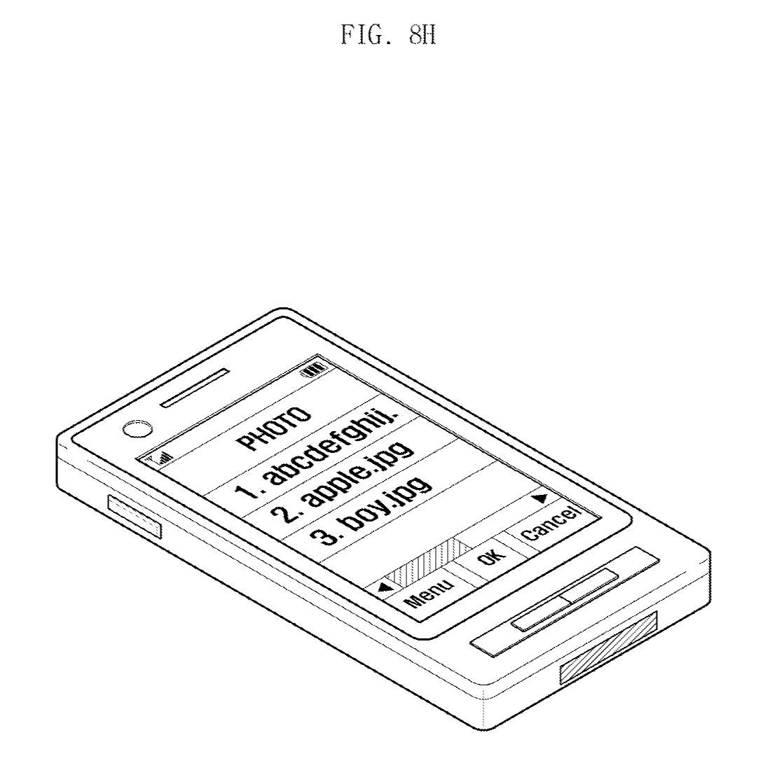

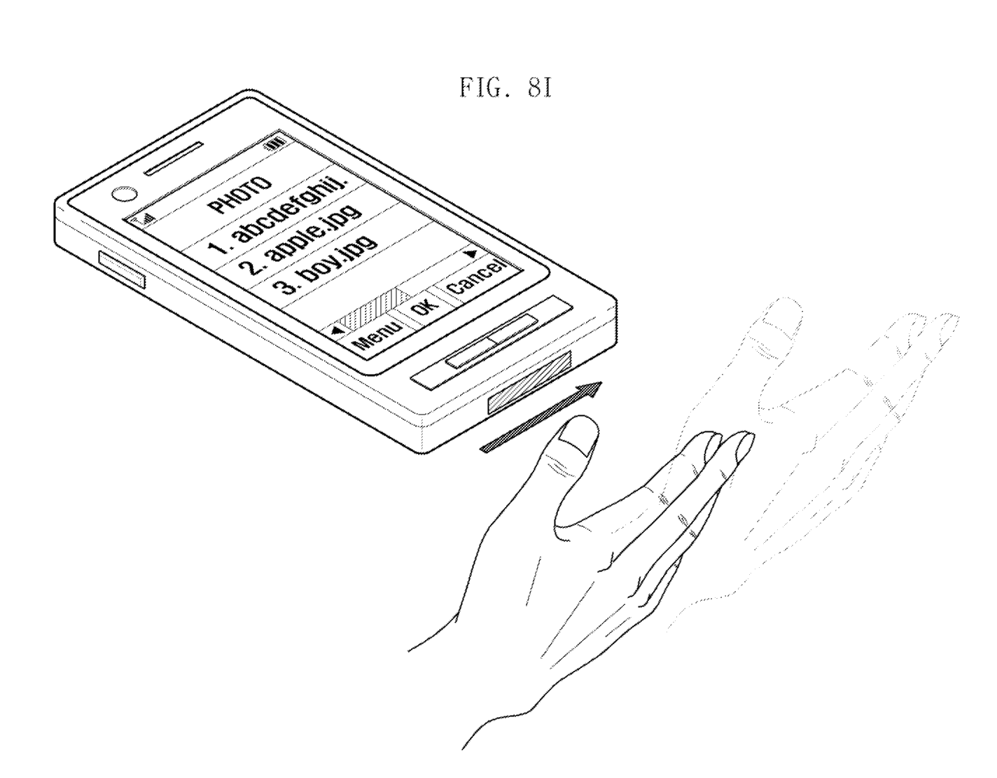

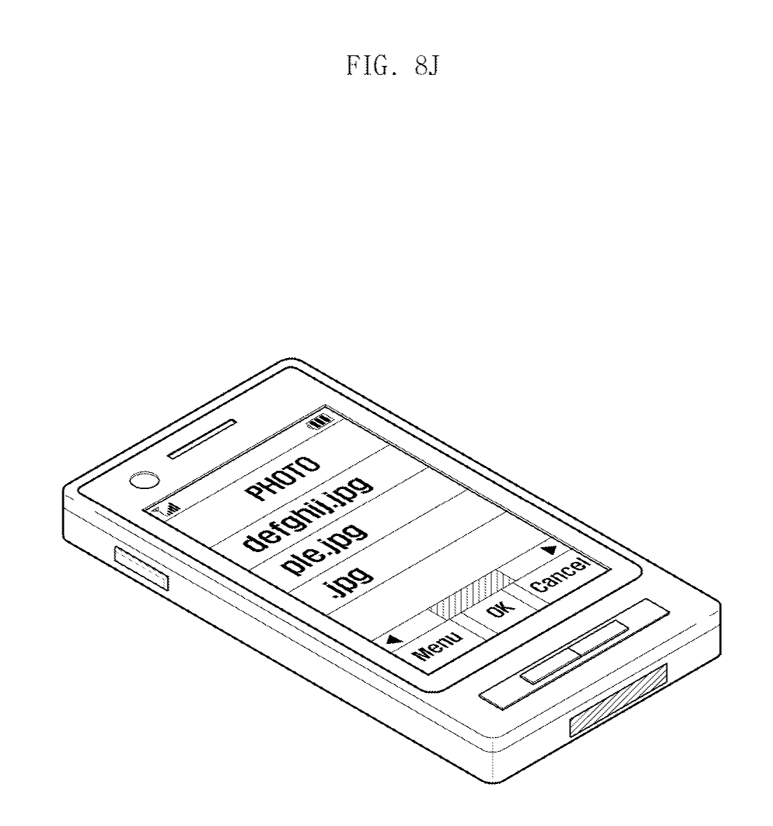

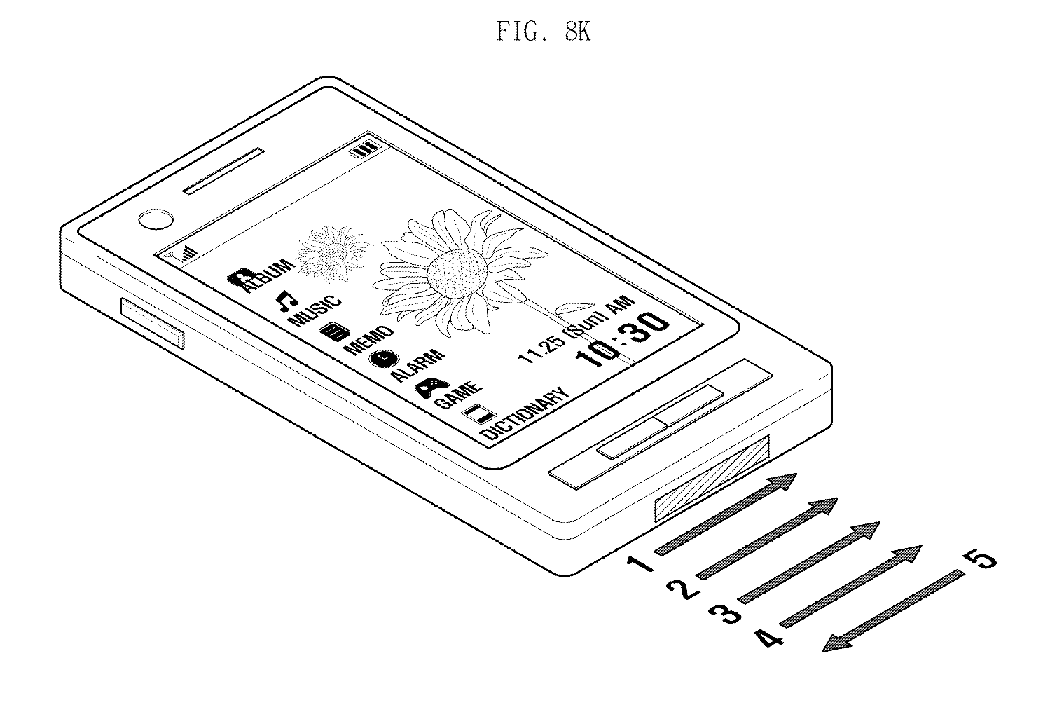

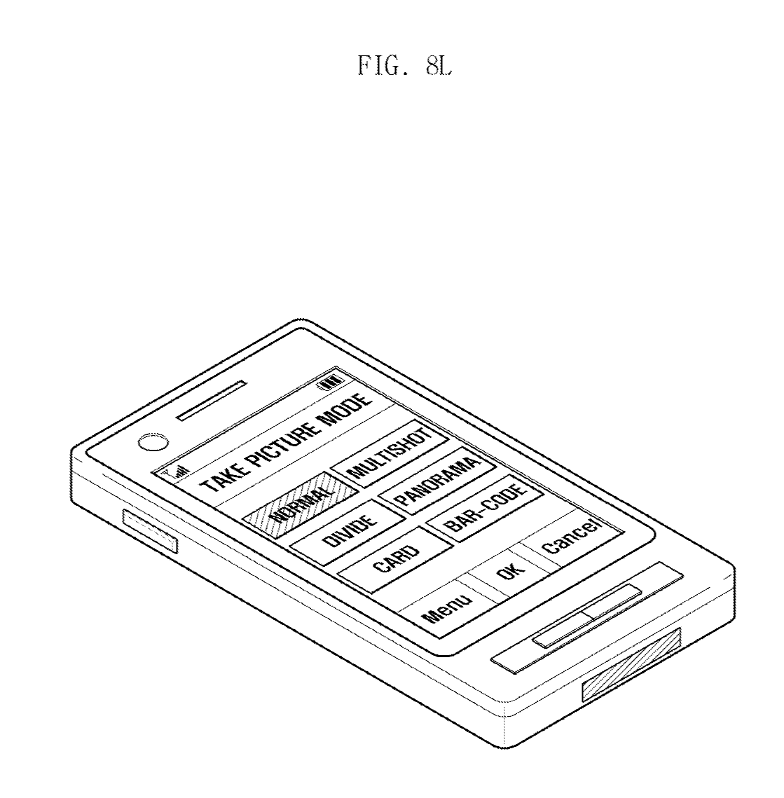

FIGS. 8A to 8L are example views illustrating a gesture-based user interface method of a mobile device according to an exemplary embodiment of the present invention. Although a camera function is shown in FIGS. 8A-8L and described below, this is exemplary only and not to be considered as a limitation of the present invention.

Referring to FIG. 8A, the control unit 100 activates a camera function in a gesture pattern recognition mode and displays several menu items of a picture-taking mode on the screen. As shown in FIG. 8B, if the first gesture occurs in a rightward direction, the control unit 100 detects the first gesture, analyzes a pattern of the first gesture, and selects a normal mode 801. The control unit may offer a visual feedback to a user by highlighting a selected item. As shown in FIG. 8C, if the second gesture occurs in an approaching direction, the control unit 100 detects the second gesture, analyzes a pattern of the second gesture, and executes a normal picture-taking mode. As shown in FIG. 8D, the control unit 100 displays a preview image on the screen.

Additionally, the control unit 100 may perform a zooming operation depending on the second gesture. For instance, as shown in FIG. 8E, if the second gesture occurs in an approaching direction, the control unit 100 enlarges a displayed image through a zoom-in operation. However, if the second gesture occurs in a receding direction as shown in FIG. 8F, the control unit 100 reduces a displayed image through a zoom-out operation. Alternatively, as shown in FIG. 8G, when the second gesture occurs in a receding direction, the control unit 100 may return to a previous stage in a picture-taking mode.

As shown in FIGS. 8H to 8J, the control unit 100 may execute a scroll operation depending on the first gesture. When a scrollable page is displayed on the screen, the control unit 100 detects the first gesture with a rightward direction and moves a scroll bar for controlling a displayed page rightward.

In addition, as shown in FIGS. 8K and 8L, the control unit 100 may activate a camera function in response to a user-defined gesture. For example, if a detected gesture has a complex pattern composed of four-time rightward moves and a one-time leftward move, the control unit 100 interprets a detected gesture as a user-defined gesture and executes the activation of a camera function assigned to that gesture.

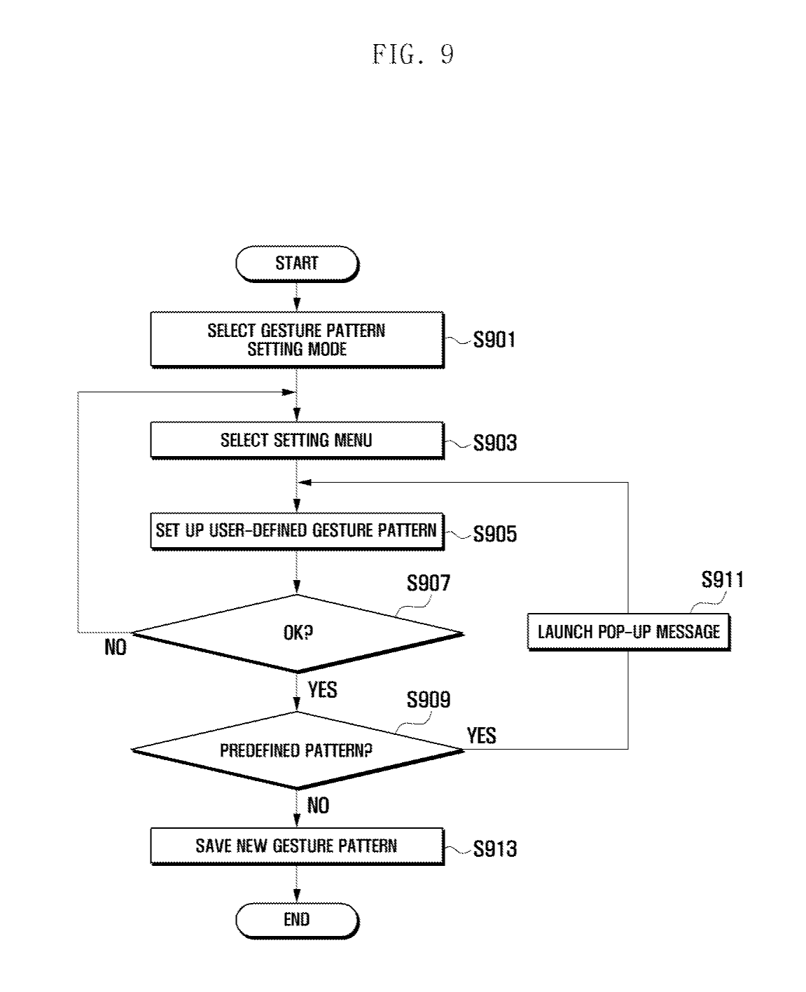

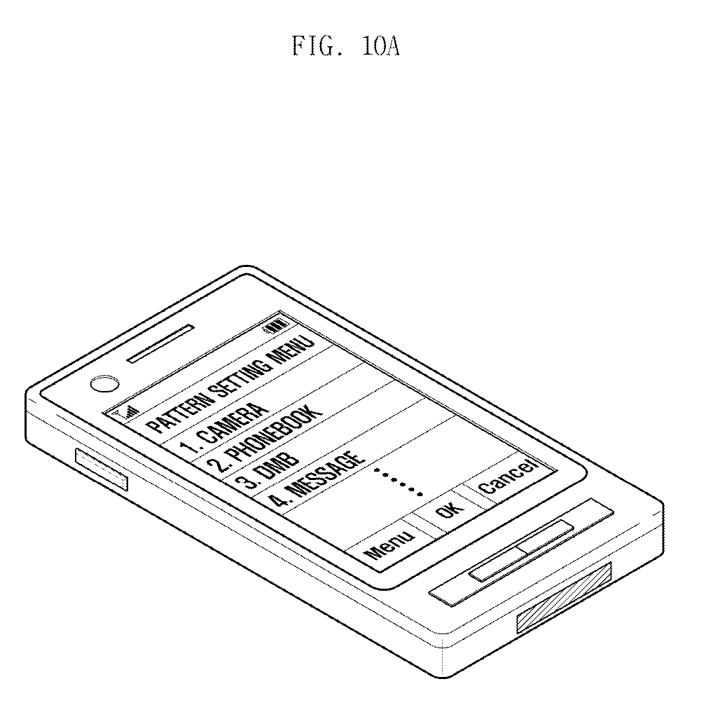

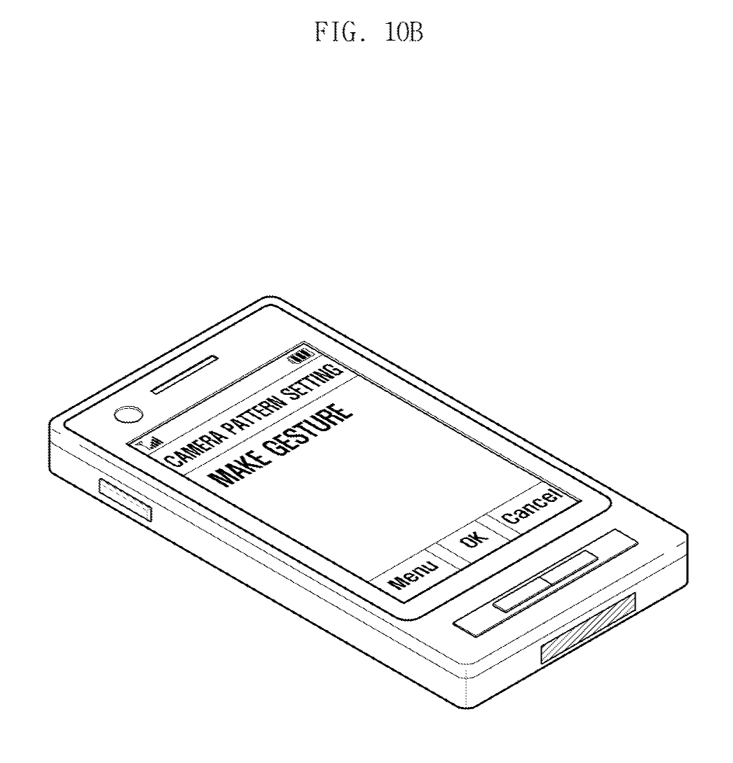

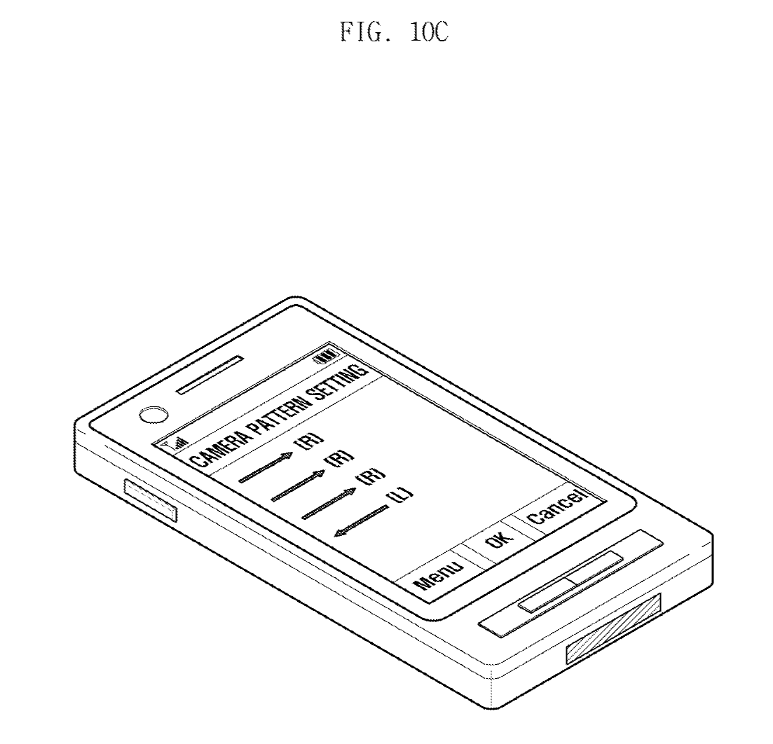

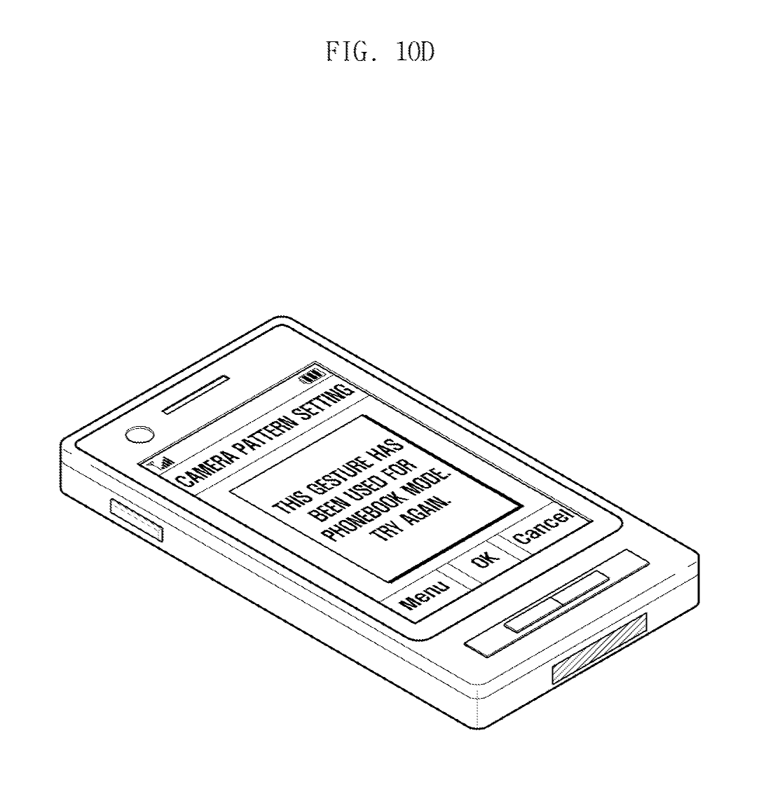

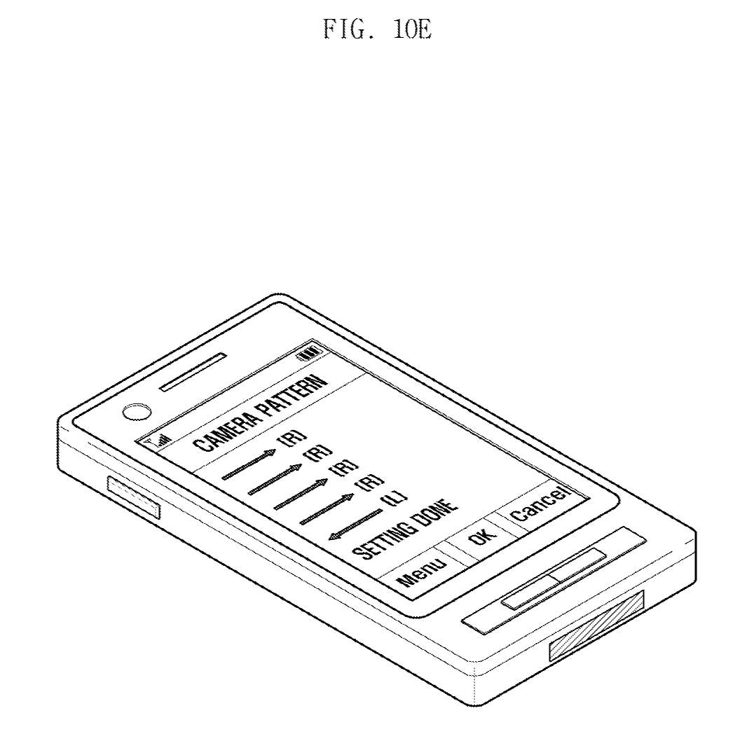

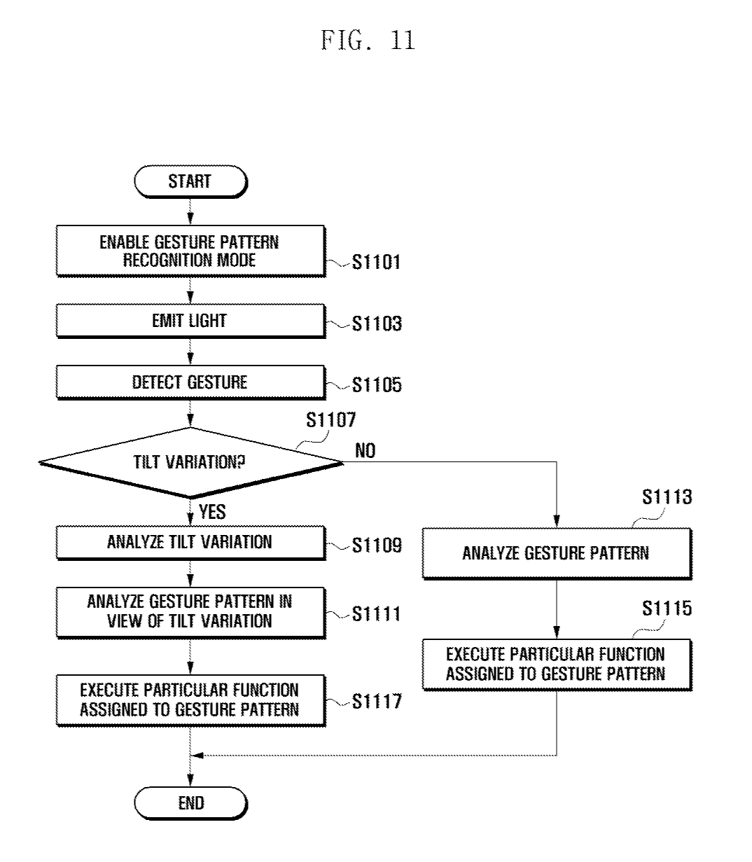

FIG. 9 is a flow diagram illustrating a process of setting up a gesture pattern to be used for a gesture-based user interface method of a mobile device in accordance with an exemplary embodiment of the present invention. FIGS. 10A to 10E are example views illustrating a process of setting up a gesture pattern for a gesture-based user interface according to an exemplary embodiment of the present invention.

Referring to FIGS. 9 to 10E, the control unit 100 receives a signal that selects a gesture pattern setting mode in step S901. A gesture pattern setting mode refers to a mode in which a user-defined gesture is established and assigned to a particular executable function by a user.

If a gesture pattern setting mode is selected, the control unit 100 offers a setting menu list on the screen and receives a selection of a specific menu in step S903. For example, as shown in FIG. 10A, the control unit 100 displays a list of menu items allowing the control based on a user-defined gesture, such as ‘Camera’, ‘Phonebook’, ‘DMB’ and ‘Message’. When a specific menu is selected, the control unit 100 performs a process of setting up a pattern of a user-defined gesture corresponding to a selected menu in step S905. If the menu item ‘Camera’ is selected, the control unit 100 displays a gesture pattern setting page which allows a user to input a desired gesture for a camera function as shown in FIG. 10B. The control unit 100 receives a gesture input from a user in this page and then displays an inputted gesture on the screen as shown in FIG. 10C.

The control unit 100 determines whether a user's gesture input is completed in step S907, which may occur when, for example, the OK button is pressed. If a gesture input is completed, the control unit 100 further determines whether an inputted gesture is equal to a predefined gesture in step S909. If a gesture input is not completed (for example, if the OK button is not pressed for a given time or if the cancel button is pressed), the control unit 100 returns to the previous step S903.

If an inputted gesture is equal to a predefined gesture, the control unit 100 displays a suitable pop-up message on the screen in step S911. For instance, as shown in FIG. 10D, the control unit 100 launches a pop-up message informing a user that an inputted gesture has been already used for any other menu, such as ‘This gesture has been used for phonebook mode. Try again.’

If an inputted gesture is not equal to any predefined gesture, the control unit 100 saves an inputted gesture as a user-defined gesture in the pattern database 152 of the memory unit 150 in step S913. For example, as shown in FIG. 10E, the control unit 100 may save a complex pattern composed of four-time rightward moves and a one-time leftward move as a user-defined gesture for executing the activation of a camera function.

FIG. 11 is a flow diagram illustrating a gesture-based user interface method depending on a tilt variation of a mobile device according to an exemplary embodiment of the present invention.

Referring to FIG. 11, the control unit 100 receives a signal that selects a gesture pattern recognition mode and enables a gesture pattern recognition mode in step S1101. The control unit 100 may send a control signal for turning on the switch 119 to the signal processing unit 120 so that the emitting part 112 may emit light. The signal processing unit 120 receives and amplifies electric power and supplies the power to the emitting part 112.

After a gesture pattern recognition mode is enabled, the emitting part 112 supplied with electric power emits light in step S1103. While light is emitted, the control unit 100 detects a gesture inputted through the receiving part 114 in step S1105. If a gesture is inputted, the control unit 100 determines whether a tilt variation is detected at the sensor unit 170 in step S1107. The sensor unit 170 may have a three-axis acceleration sensor which detects the magnitude and direction of the motion of the mobile device in the three dimensional space and offers detection data to the control unit 100. Alternatively or additionally, the sensor unit 170 may have a geomagnetic sensor which detects the direction of the mobile device based on absolute orientation and offers detection data to the control unit 100.

If a tilt variation is detected, the control unit 100 analyzes a tilt variation in step S1109 and further analyzes a pattern of an inputted gesture in view of a tilt variation in step S1111. The control unit 100 may interpret the same gesture pattern as different meanings, depending on a detected tilt variation. If a tilt variation is not detected, the control unit 100 analyzes a pattern of an inputted gesture in step S1113 and then executes a particular function assigned to a gesture pattern in step S1115.

After the pattern analysis in step S1111, the control unit 100 executes a particular function assigned to a gesture pattern determined in view of a tilt variation in step S1117. For example, if a tilt recognized by the sensor unit 170 is at a right angle with the ground, the control unit 100 may interpret a gesture pattern as a default meaning. If a tilt recognized by the sensor unit 170 is at an angle of 45 degrees with the ground, the control unit 100 may interpret a gesture pattern as a different meaning.

As fully discussed heretofore, a mobile device according to this invention may realize a user interface based on a gesture detected through a proximity sensor. In addition, a mobile device according to this invention may execute a variety of applications by using a proximity sensor regardless of having a touch screen or having a keypad. Also, a mobile device according to this invention may offer a user-oriented interface by allowing a user-defined gesture adapted to a user's intention.

While this invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A gesture-based user interface method in a mobile device having a proximity sensor, the method comprising:
enabling proximity sensing through the proximity sensor;
detecting a specific gesture through the proximity sensing;
analyzing a pattern of the specific gesture; and
executing a particular function assigned to the pattern.

2. The method of claim 1, wherein the enabling of the proximity sensing comprises:
turning on a switch when receiving a control signal;
emitting light when the switch is turned on; and
activating a gesture pattern recognition mode for interpreting the pattern based on the specific gesture.

3. The method of claim 1, wherein the specific gesture includes at least one of a distance-dependent gesture and a direction-dependent gesture.

4. The method of claim 1, wherein the detecting of the specific gesture comprises:
emitting light through an emitting part;
receiving the light through a plurality of receiving parts, the light being received due to the specific gesture; and
processing a signal of the received light.

5. The method of claim 4, wherein the processing of the signal includes:
filtering and amplifying the signal of the received light; and
sending the amplified signal to at least one of a control unit and a plurality of comparators, each of the plurality of comparators comparing the amplified signal with a given threshold value.

6. The method of claim 5, wherein the detecting of the specific gesture comprises:
analyzing data obtained by the comparison performed in each comparator; and
determining the strength of light using the analyzed data.

7. The method of claim 4, wherein the detecting of the specific gesture comprises:
identifying a time when the light detected by each receiving part is received; and
determining the direction of the specific gesture by performing an operation for the identified time.

8. The method of claim 1, wherein the analyzing of the pattern of the specific gesture includes:
determining a single pattern with an upward, downward, rightward, or leftward direction; and
determining a user-defined pattern composed of at least two single patterns in a gesture pattern setting mode.

9. The method of claim 8, wherein the gesture pattern setting mode comprises a mode in which the user-defined gesture is established and assigned to a particular executable menu or function by a user.

10. The method of claim 9, further comprising:
saving the user-defined gesture in a pattern database.

11. The method of claim 1, wherein the analyzing of the pattern of the specific gesture comprises:
determining a tilt variation of the mobile device; and
interpreting the pattern of the specific gesture based on the tilt variation.

12. The method of claim 11, wherein the determining of the tilt variation includes detecting the tilt variation using at least one of a three-axis geomagnetic sensor and a three-axis acceleration sensor.

13. The method of claim 1, wherein the analyzing of the pattern of the specific gesture comprises:
identifying two or single patterns, each having an upward, downward, rightward, leftward, approaching, or receding direction; and
identifying the pattern of the specific gesture as a combination of two or more single patterns.

14. A mobile device having a gesture-based user interface, the mobile device comprising:
a proximity sensor unit including an emitting part for emitting light when a switch is turned on through a control signal, and a plurality of receiving parts for detecting the light reflected from a specific gesture; and
a control unit for detecting the specific gesture, for analyzing a pattern of the specific gesture, and for executing a particular function assigned to the pattern.

15. The mobile device of claim 14, wherein the specific gesture includes at least one of a distance-dependent gesture and a direction-dependent gesture.

16. The mobile device of claim 14, further comprising:
a signal processing unit for filtering a signal of the light, for amplifying the filtered signal, and for sending the amplified signal to at least one of a control unit and a plurality of comparators, each of which compares the amplified signal with a given threshold value.

17. The mobile device of claim 14, wherein the control unit analyzes data obtained by comparison performed in each comparator, and determines the strength of light using the analyzed data.

18. The mobile device of claim 14, wherein the control unit identifies a time when the light detected by each receiving part is received, and determines the direction of the specific gesture by performing an operation for the identified time.

19. The mobile device of claim 14, wherein the control unit activates a gesture pattern recognition mode for interpreting the pattern based on the specific gesture.

20. The mobile device of claim 14, wherein the control unit determines a single pattern with an upward, downward, rightward, or leftward direction, and determines a user-defined pattern composed of at least two single patterns in a gesture pattern setting mode.

21. The mobile device of claim 20, wherein the gesture pattern setting mode is a mode in which the user-defined gesture is established and assigned to a particular executable menu or function by a user.

22. The mobile device of claim 21, further comprising:
a memory unit for saving the user-defined gesture in a pattern database.

23. The mobile device of claim 14, further comprising:
a sensor unit for detecting a tilt variation using at least one of a three-axis geomagnetic sensor and a three-axis acceleration sensor.

24. The mobile device of claim 23, wherein the control unit determines the tilt variation of the mobile device using the sensor unit, and interprets the pattern of the specific gesture in view of the tilt variation.

25. A method of defining a gesture pattern in a mobile device, the method comprising:
identifying an operation to be performed by a gesture;
receiving a gesture from the user; and
when the received gesture does not correspond to a previously defined gesture, saving pattern information corresponding to the received gesture.

26. The method of claim 25, wherein the receiving of the gesture from the user comprises:
enabling a proximity sensor of the mobile device;
detecting the gesture via the proximity sensor; and
analyzing a pattern of the gesture,
wherein the saving of the pattern information comprises saving the analyzed pattern.
